(19) United States
(12) Patent Application Publication
(10) Pub. No.: US 2026/0111155 A1
(43) Pub. Date: Apr. 23, 2026

(54) METHODS FOR INTELLIGENTLY MANAGING CLOUD PRINTING OPERATIONS

(71) Applicant: Kyocera Document Solutions Inc., Osaka (JP)

(72) Inventor: Javier A. MORALES, Rochester, NY (US)

(73) Assignee: Kyocera Document Solutions Inc., Osaka (JP)

(21) Appl. No.: 18/921,595

(22) Filed: Oct. 21, 2024

(51) Int. Cl. G06F 3/12

(52) U.S. Cl. CPC G06F 3/1207; G06F 3/1237; G06F 3/1288

(57) ABSTRACT

A printing system includes a printing device having a digital front end (DFE). The DFE communicates with a cloud server system within the printing system. The cloud server system includes a paper catalog for the papers used at the printing devices within the printing system. For each printing device, the cloud server system defines a set of papers based on data or information related to the printing device or to a paper being used at the printing device. The set of papers is a number of papers from the paper catalog selected based on the data. The set of papers are provided to the DFE of the printing device. Paper usage is monitored at the printing device and used to adjust the papers within the set of papers stored within the DFE.

### FIELD OF THE INVENTION

The present invention relates to methods for managing printing operations in a cloud printing environment using a paper catalog. More particularly, the present invention relates to using a cloud server system to manage printing operations at a printing device using a subset of papers from the paper catalog.

### DESCRIPTION OF THE RELATED ART

Production printing devices come with a standard media or paper library. These libraries, however, are seldom matches to the papers that a specific print shop uses as there are thousands of papers in the market. For example, some paper catalogs may contain over 700 inkjet treated papers. Inkjet treated papers are a small portion of all available papers. In addition, these papers come in a variety of sizes and weights.

It may not be practical to include definitions for even a small fraction of papers with the digital front ends (DFEs) for a number of reasons. The paper catalog in most printing devices do not support holding definitions for thousands of different papers that are generally available. Further, a large number of papers may make it difficult for most print shops to find the papers that are actually used for printing. Moreover, many papers are available regionally so even print shops that offer hundreds of papers may find that the majority of defined papers are not available in their market.

For this reason, paper catalogs may be defined regionally as they are validated by sales companies. These papers are added to a printing device during installation. This process may make it difficult to add new paper definitions for newly qualified papers. In some instances, these definitions are imported into existing printing devices for customers that want to use them. In a cloud printing environment, this process may be complex and cumbersome.

### SUMMARY OF THE INVENTION

A method for managing printing operations in a printing system is disclosed. The method includes enabling a set of papers from a paper catalog stored in a cloud server system at a printing device. The method also includes monitoring a use of at least one paper of the set of papers during production at the printing device. The method also includes adjusting the set of papers based on the use of the at least one paper by a digital front end (DFE) of the printing device. The method also includes providing the adjusted set of papers for a print job at the printing device.

In additional embodiments, the adjusting the set of papers includes removing the at least one paper from the set of papers.

In additional embodiments, the method also includes receiving a request for a paper not within the set of papers for printing at the printing device. The method also includes adding the requested paper to the set of papers. The method also includes downloading at least one attribute for the requested paper from the paper catalog in the cloud server system.

In additional embodiments, the method also includes defining a subset of papers from the set of papers based on a parameter of at least one subset paper of the subset of papers. The method also includes adjusting the set of papers based on the use of the parameter of the subset of papers. The parameter includes at least one of a size of the at least one subset paper of the subset of papers and a weight of the at least one subset paper of the subset of papers.

In additional embodiments, the method also includes updating paper definitions for each paper of the set of papers form the paper catalog from the cloud server system at the printing device.

In additional embodiments, the method also includes adding the printing device to the printing system. The method further includes connecting the printing device to the cloud server system. The method further includes downloading the set of papers to the printing device based on a location of the printing device.

A method for managing printing operations for a printing system is disclosed. The method includes capturing a barcode associated with a paper specified by a print job at a printing device within the printing system. The method also includes accessing a cloud server system of the printing system by a digital front end (DFE) of the printing device. The method also includes identifying a paper catalog entry for the paper in a paper catalog at the cloud server system. The method also includes generating a set of papers from the paper catalog based on the paper catalog entry. The method also includes downloading the set of papers from the cloud server system to the DFE of the printing device.

In additional embodiments, the method also includes receiving a print job within the printing system for the printing device. The print job includes a setting related to the paper. The method also may include scanning the barcode for the paper at the printing device. In additional embodiments, the set of papers include additional versions of the paper that vary in weight or size.

A method for managing printing operations is disclosed. The method includes receiving an attribute defined in a print ticket setting for a print job received for a printing device in a printing system. The method also includes accessing a cloud server system of the printing system by a digital front end of the printing device. The method also includes identifying at least one paper catalog entry from a paper catalog having the attribute. The paper catalog is hosted by the cloud server system. The method also includes generating a set of papers from the paper catalog based on the at least one paper catalog entry. The method also includes downloading the set of papers from the cloud server system to the DFE of the printing device.

In additional embodiments, the set of papers includes additional versions of the at least one paper that vary in weight or size.

In additional embodiments, the method also includes generating the set of papers based also based on a print engine setting of the printing device. The print engine setting may be a print engine speed.

### BRIEF DESCRIPTION OF THE DRAWINGS

Various other features and attendant advantages of the present invention will be more fully appreciated when considered in conjunction with the accompanying drawings.

FIG. 1A illustrates a printing system having a printing device for printing documents according to the disclosed embodiments.

FIG. 1B illustrates a digital front end (DFE) for a printing device according to the disclosed embodiments.

FIG. 2 illustrates a block diagram of components of the printing device for use within the printing system according to the disclosed embodiments.

FIG. 3 illustrates a block diagram of a paper catalog for use within the printing system according to the disclosed embodiments.

FIG. 4 illustrates an example listing of attributes for a specific paper according to the disclosed embodiments.

FIG. 5 illustrates a block diagram of a cloud server system for use within the printing system according to the disclosed embodiments.

FIG. 6 illustrates a flowchart for managing printing operations using a set of papers from a paper catalog of a cloud server system according to the disclosed embodiments.

FIG. 7 illustrates a flowchart for generating a set of papers based on a barcode or an attribute defined in a print ticket of a print job according to the disclosed embodiments.

### DETAILED DESCRIPTION OF THE PREFERRED EMBODIMENTS

Reference will now be made in detail to specific embodiments of the present invention. Examples of these embodiments are illustrated in the accompanying drawings. Numerous specific details are set forth in order to provide a thorough understanding of the present invention. While the embodiments will be described in conjunction with the drawings, it will be understood that the following description is not intended to limit the present invention to any one embodiment. On the contrary, the following description is intended to cover alternatives, modifications, and equivalents as may be included within the spirit and scope of the appended claims.

The disclosed embodiments implement a cloud paper catalog that intelligently interacts with the controllers or digital front ends (DFEs) attached to production printing devices. The printing system may include a master media catalog with every paper that has been validated for every supported printing device. The paper catalog may represent thousands of paper definitions along with options for weights and sizes. In addition, the paper definitions may include metadata to ensure that operators only see relevant paper definitions. Paper metadata may include information about market availability or supported printing devices.

When a printing device is first installed, the newly installed printing device may automatically query the cloud media, or paper, catalog for qualified papers that are available in its region. The printing device may determine its location using known mechanisms. The printing device may download, using its DFE, all qualified papers. Alternatively, the printing device may download a minimal list of papers that have been tagged as “preferred” papers for new installations. In other embodiments, the printing device may present a list of products to the operator. The operator would then select which products to download along with the relevant weights and sizes.

The printing device may retain a subscription to the cloud media catalog and automatically download updated paper definitions as they become available. This feature ensures that the paper has the most current paper definitions. During production, the printing device automatically monitors which papers which papers from the paper catalog are actually used at the printing device. The printing device may unload unused papers automatically. This feature would streamline paper selection for operators as the available papers would be based on the papers that are actually used for production. Similarly, the printing device may unload specific weight and size based on usage.

In instances where the printing device receives a request for a paper that is not in its catalog, the printing device may query the cloud media catalog and look for the defined paper. If the paper is found, then the printing device would download and install it so that it can be used for the job. Clients may define print tickets with minimal information about the paper catalog entry but the DFE would receive complete paper catalog entries that may include not just the paper attributes but print engine attributes needed to ensure optimal production when using the selected paper.

These features may eliminate the need for the operator to edit the paper catalog as the system could do this automatically according to the disclosed embodiments. In addition, the DFE may provide the operator the ability to define a job's paper catalog by scanning a barcode, such as a UPC barcode. The DFE would find the paper in the cloud media catalog in order to download and install that paper. The DFE also may download and install additional weights and sizes of the paper. Alternatively, the printing system may download and install those on demand.

Further, for cases in which jobs are received with just paper catalog attributes, the disclosed embodiments may query the cloud media catalog and return a list of papers that match the selected attributes. The operator may then select the paper definition that matches the paper that the operator is actually trying to use. The disclosed embodiments may download and install the paper along with weights and sizes. These features may minimize paper catalog editing by customers while ensuring that printing devices use a centrally and optimally defined paper catalog definition, including vendor-specific settings for optimized production.

Moreover, the disclosed embodiments may allow the operator to tab paper sizes as either “standard,” such as A4, A3, SRA3, and the like, and “optional,” such as 13×19, A4 Tab, and the like. The operator may globally specify whether all, standard, and optional sizes should be downloaded for papers. In addition, the operator may make these choices for specific papers. Further, the operator may add or delete sizes for a downloaded paper. In this instance, all paper attributes except for the size are synced with the cloud server. The operator has the option to change the above to, for example, revert a paper by using only the standard sizes.

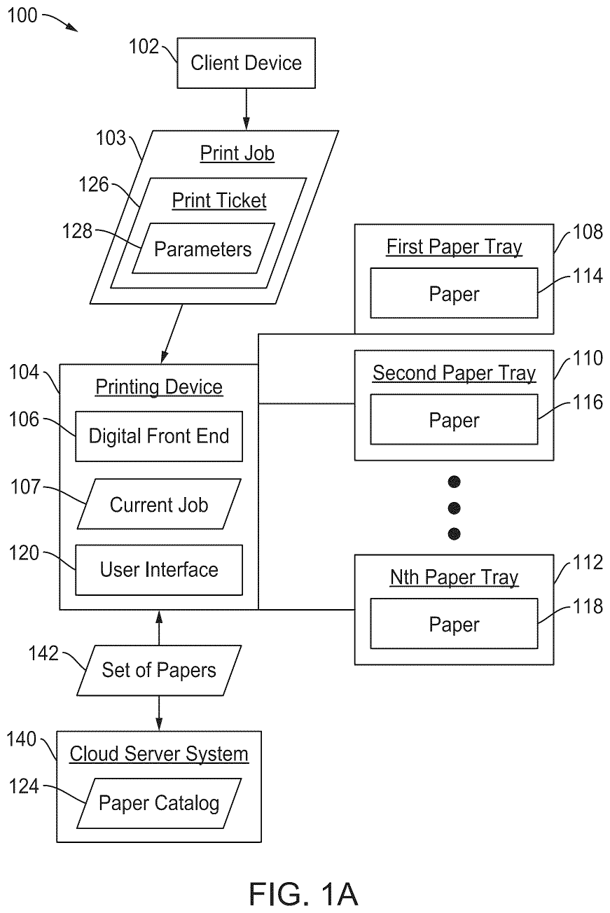

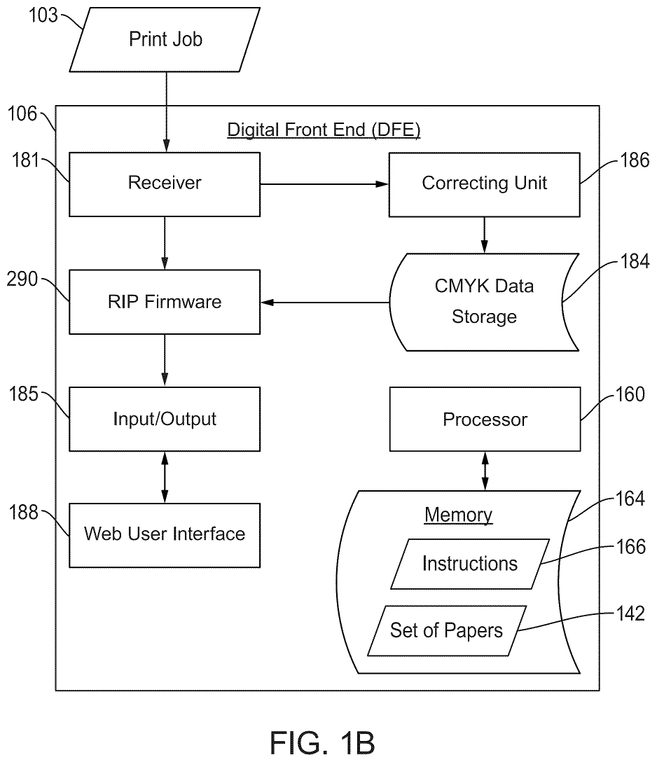

FIG. 1A depicts a printing system 100 for printing documents according to the disclosed embodiments. Printing system 100 includes printing device 104. Printing device 104 is disclosed in greater detail below. Printing device 104 may receive one or more print jobs 103 within printing system 100. For example, client device 102 may generate and send print job 103 to printing device 104. In some embodiments, printing device 104 may be a production printing device in that print jobs are provided through client device 102, which is attached to the printing device. Such a print job may require 1000s of pages or even 100,000 pages or more.

Print job 103 may include a print ticket 126 that sets forth one or more parameters 128 for the print job. For example, print ticket 126 may specify a size for a sheet of print job 103 as well as weight, quality of paper, color of paper, punched holes, and the like. The operator may generate print ticket 126 when submitting print job 103 for printing within printing system 100. Information from print ticket 126, such as one or more parameters 128, may be used to generate a list of recommended papers to display for print job 103.

Printing device 104 may receive print job 103 as it is processing and printing current job 107. Current job 107 may use different paper or media than print job 103. As such, printing device 104 may include a plurality of paper trays to supply papers of various types, sizes, weights, and the like. Thus, printing device 104 includes first paper tray 108 having paper 114, second paper tray 110 having paper 116, and so on to Nth paper tray 112 having paper 118. Current job 107 may use paper from one or more of these paper trays. In some embodiments, paper 114, paper 116, and paper 118 are different types of paper or different media. For example, current job 107 may use paper 116 from second paper tray 110 while print job 103 may require paper 114 from first paper tray 108.

User interface 120 may be in operation panel 208, disclosed below, or part of digital front end (DFE) 106. DFE 106 is disclosed in greater detail below. DFE 106 may process print jobs and act as a controller for printing device 104. Alternatively, user interface 120 may be displayed on client device 102. The disclosed embodiments may use user interface 120 to select papers for print job 103.

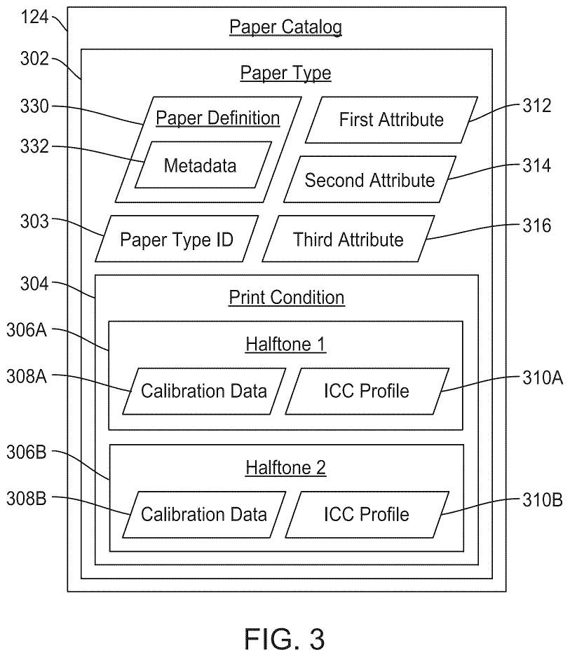

System 100 also includes cloud server system 140. Cloud server system 140 may include one or more servers that host paper catalog 124, as well as other features. Paper catalog 124 is configured to organize and store existing calibration data and ICC profiles for a plurality of papers. Upon selection of a paper for printing at printing device, paper catalog 124 may be accessed to complete print job 103 according to the expectations associated with the print job. Paper catalog 124 is disclosed in greater detail below by FIG. 3. In some embodiments, DFE 106 may include multiple paper catalogs.

Cloud server system 140 may download a set of papers 142 to printing device 104. In some embodiments, all the papers listed within paper catalog 124 may be downloaded to DFE 106 of printing device 104. In other embodiments, set of papers 142 includes one or more paper entries within paper catalog 124 that are provided to DFE 106 based on specified criteria. These features are disclosed in greater detail below. Through the use of papers 114, 116, and 118 at printing device 104, set of papers 142 may be modified.

FIG. 1B depicts a block diagram of DFE 106 according to the disclosed embodiments. DFE 106 includes a receiver 181, a RIP firmware 290, a CMYK data storage 184, an input/output connector 185, and a correcting unit 186. Additional components within DFE 106 may be implemented, as disclosed above and below.

Receiver 181 receives print job 103 received within system 100 and outputs the print job to RIP firmware 290. Receiver 181 also may receive color information for the document or documents within the print job. It may output the color information to correcting unit 186. The print job received by receiver 181 is associated with image data to be printed on print media. It also may include print condition information including information for indicating single-sided printing or two-sided printing or print medium-type information along with other data associated with the print job.

RIP firmware 290 converts image data associated with the print job into raster data to thereby generate rendering data, and outputs the generated rendering data. RIP firmware 290 also converts the rendering data into rendering data in a CMYK format. When the rendering data is originally in the CMYK format, or CMYK rendering data, the conversion may not be performed. RIP firmware 290 may perform gradation conversion of the CMYK rendering data, with reference to one or more tone reproduction curves (TRCs). A TRC refers to data indicating the relationship between a colored gradation value for rendering data and print color, or print density, on a given print medium.

When print color provided alters over time, the TRCs stored in CMYK data storage 184 may be each deviated from an actually measured relationship between a colored value and print color. When the TRC is shifted from the actual relationship, gradation conversion for each colored gradation value cannot match a desired print color. In this regard, correcting unit 186 corrects the deviation, from the actual relationship, of the TRC stored in CMYK data storage 184 in order to allow each colored gradation value to match a desired print color. Correcting unit 186 converts RGB color information obtained through receiver 181 into CMYK color information. Correcting unit 186 may use the converted CMYK color information to generate the TRC. The TRC stored in CMYK data storage 184 is replaced with the generated TRC. Correcting unit 186 may correct the TRC. Correcting unit 186 may rewrite a part of the TRC stored in CMYK data storage 184 to thereby correct the TRC.

The rendering data generated by RIP firmware 290 may be transmitted within printing system 100 via input/output connector 185. The print condition information and the print medium type, as well as the rendering data, may be transmitted to a selected printing device within printing system 100. As disclosed above, the rendered data may be in a file format acceptable for a printing device such that the print job is provided directly to the print engine of the printing device.

DFE 106 also includes web user interface 188 that may communicate with other devices within printing system 100, if it is located at a separate device, using, for example, input/output connector 185. Web user interface 188, or web application, allows a user of the DFEs of other printing devices to interact with content or software running on DFE 106.

DFE 106 also includes processor 160 and memory storage 164. Processor 160 and memory storage 164 are connected to the other components within DFE 106. Memory storage 164 may store instructions 166, that include code that, when executed by processor 160, configures DFE 106 to perform the disclosed processes. Memory storage 164 also may store set of papers 142 received from cloud server system 140. DFE 106 may treat set of papers 142 as its own paper catalog within printing device 104. In some embodiments, information for the papers in set of papers 142 is provided to CMYK data storage 184. For example, TRCs for each paper may be provided from paper entries within set of papers 142.

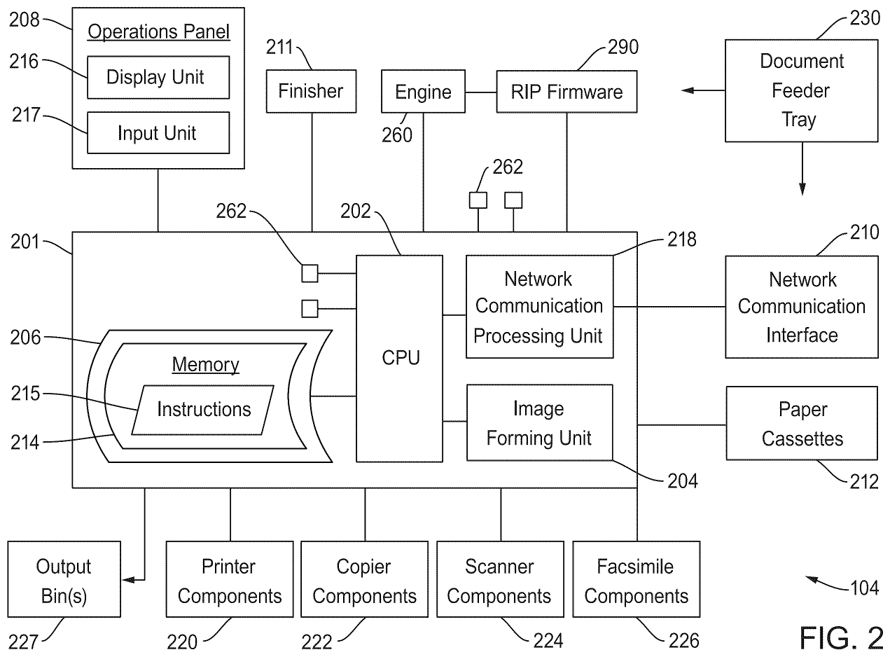

FIG. 2 depicts a block diagram of components of printing device 104 according to the disclosed embodiments. The architecture shown in FIG. 2 may apply to any multi-functional printing device or image forming apparatus that performs various functions, such as printing, scanning, storing, copying, and the like within system 100. As disclosed above, printing device 104 may send and receive data from DFE 106 and other devices within system 100.

Printing device 104 includes a computing platform 201 that performs operations to support these functions. Computing platform 201 includes a computer processing unit (CPU) 202, an image forming unit 204, a memory unit 206, and a network communication interface 210. Other components may be included but are not shown for brevity. Printing device 104, using computing platform 201, may be configured to perform various operations, such as scanning, copying, printing, receiving or sending a facsimile, or document processing. As such, printing device 104 may be a printing device or a multi-function peripheral including a scanner, and one or more functions of a copier, a facsimile device, and a printer. To provide these functions, printing device 104 includes printer components 220 to perform printing operations, copier components 222 to perform copying operations, scanner components 224 to perform scanning operations, and facsimile components 226 to receive and send facsimile documents. CPU 202 may issue instructions to these components to perform the desired operations.

Printing device 104 also includes a finisher 211 and one or more paper cassettes 212. Finisher 211 includes rotatable downstream rollers to move papers with an image formed surface after the desired operation to a tray. Finisher 211 also may perform additional actions, such as sorting the finished papers, binding sheets of papers with staples, doubling, creasing, punching holes, folding, and the like.

Paper cassettes 212 supply paper to various components 220, 222, 224, and 226 to create the image formed surfaces on the papers. Paper cassettes 212 also may be known as paper trays, shown as paper trays 108, 110, and 112 in FIG. 1A. Paper cassettes 212 may include papers having various sizes, colors, composition, and the like. Papers or media within paper cassettes 212 may be considered “loaded” onto printing device 104. The information for printing these papers may be captured in a paper catalog stored at DFE 106. Paper cassettes 212 may be removed to refill as needed. The printed papers from components 220, 222, 224, and 226 are placed within one or more output bins 227. One or more output bins 227 may have an associated capacity to receive finished print jobs before it must be emptied or printing paused. The output bins may include one or more output trays.

Document processor input feeder tray 230 may include the physical components of printing device 104 to receive papers and documents to be processed. Feeder tray also may refer to one or more input trays for printing device 104. A document is placed on or in document processor input feeder tray 230, which moves the document to other components within printing device 104. The movement of the document from document processor input feeder tray 230 may be controlled by the instructions input by the user. For example, the document may move to a scanner flatbed for scanning operations. Thus, document processor input feeder tray 230 provides the document to scanner components 224. As shown in FIG. 2, document processor input feeder tray 230 may interact with print engine 260 to perform the desired operations.

Memory unit 206 includes memory storage locations 214 to store instructions 215.

Instructions 215 are executable on CPU 202 or other processors associated with printing device 104, such as any processors within components 220, 222, 224, or 226. Memory unit 206 also may store information for various programs and applications, as well as data specific to printing device 104. For example, a storage location 214 may include data for running an operating system executed by computing platform 201 to support the components within printing device 104. In some embodiments, memory unit 206 may store the tokens and codes used in performing operations for printing device 104.

Memory unit 206 may comprise volatile and non-volatile memory. Volatile memory may include random access memory (RAM). Examples of non-volatile memory may include read-only memory (ROM), flash memory, electrically erasable programmable read-only memory (EEPROM), digital tape, a hard disk drive (HDD), or a solid-state drive (SSD). Memory unit 206 also includes any combination of readable or writable volatile memories or non-volatile memories, along with other possible memory devices.

Computing platform 201 may host one or more processors, such as CPU 202. These processors are capable of executing instructions 215 stored at one or more storage locations 214. By executing these instructions, the processors cause printing device 104 to perform various operations. The processors also may incorporate processing units for specific purposes, such as application-specific integrated circuits (ASICs) and field programmable gate arrays (FPGAs). Other processors may be included for executing operations particular to components 220, 222, 224, and 226. In other words, the particular processors may cause printing device 104 to act as a printer, copier, scanner, and a facsimile device.

Printing device 104 also includes an operations panel 208, which may be connected to computing platform 201. Operations panel 208 may include a display unit 216 and an input unit 217 for facilitating interaction with a user to provide commands to printing device 104. Display unit 216 may be any electronic video display, such as a liquid crystal display (LCD). Input unit 217 may include any combination of devices that allow users to input information into operations panel 208, such as buttons, a touch screen, a keyboard or keypad, switches, dials, and the like. Preferably, input unit 217 includes a touch-screen digitizer overlaid onto display unit 216 that senses touch to receive inputs from the user. By this manner, the user interacts with display unit 216. Using these components, one may enter codes or other information into printing device 104.

Display unit 216 also may serve as to display results from DFE 106, if applicable. DFE 106 may send calibration and paper catalog information to printing device 104 for display. For example, the operator at DFE 106 may send a calibration to printing device 104. Printing device 104 displays paper type and any other information needed to complete the calibration.

Printing device 104 also includes network communication processing unit 218. Network communication processing unit 218 may establish a network communication using network communication interface 210, such as a wireless or wired connection with one or more other image forming apparatuses or a network service. CPU 202 may instruct network communication processing unit 218 to transmit or retrieve information over a network using network communication interface 210. As data is received at computing platform 201 over a network, network communication processing unit 218 decodes the incoming packets and delivers them to CPU 202. CPU 202 may act accordingly by causing operations to occur on printing device 104. CPU 202 also may retrieve information stored in memory unit 206, such as settings for printing device 104.

Printing device 104 also includes print engine 260, as disclosed above. Engine 260 may be a combination of hardware, firmware, or software components that act accordingly to accomplish a task. For example, engine 260 is comprised of the components and software to print a document. It may receive instructions from computing platform 201 after user input via operations panel 208. Alternatively, engine 260 may receive instructions from other attached or linked devices.

Engine 260 manages and operates the low-level mechanism of the printing device engine, such as hardware components that actuate placement of ink or toner onto paper.

Engine 260 may manage and coordinate the half-toner, toner cartridges, rollers, schedulers, storage, input/output operations, and the like. Raster image processor (RIP) firmware 290 that interprets the page description languages (PDLs) would transmit and send instructions down to the lower-level engine 260 for actual rendering of an image and application of the ink onto paper during operations on printing device 104.

Printing device 104 may include one or more sensors 262 that collect data and information to provide to computing platform 201 or CPU 202. Each sensor 262 may be used to monitor certain operating conditions of printing device 104. Sensors 262 may be used to indicate a location of a paper jam, failure of hardware or software components, broken parts, operating system problems, document miss-feed, toner level, as well as other operating conditions. Sensors 262 also may detect the number of pages printed or processed by printing device 104. When a sensor 262 detects an operational issue or failure event, it may send a signal to CPU 202. CPU 202 may generate an error alert associated with the problem. The error alert may include an error code.

Some errors have hardware-related causes. For example, if a failure occurred in finisher 211, such as a paper jam, display unit 216 may display information about the error and the location of the failure event, or the finisher. In the instance when the paper jam occurs in paper cassettes 212, display unit 216 displays the information about the jam error as located in one of the paper cassettes.

Some errors have a type of firmware-related cause. For example, network communication processing unit 218 may cause a firmware or software error. Display unit 216 may display the firmware-related error, any applicable error codes, and provide recommendations to address the error, such as reboot the device. Memory unit 206 may store the history of failure events and occurred errors with a timestamp of each error.

Printing device 104 communicates with other devices within system 100 via network communication interface 210 by utilizing a network protocol, such as the ones listed above. In some embodiments, printing device 104 communicates with other devices within system 100 through REST API, which allows the server to collect data from multiple devices within system 100. REST API and SOAP are application protocols used to submit data in different formats, such as files, XML messages, JSON messages, and the like. By utilizing applicable network communication protocols and application protocols, printing device 104 submits and receives data from DFE 106 as well as other devices within system 100.

FIG. 3 depicts a block diagram of paper catalog 124 for use within printing system 100 according to the disclosed embodiments. As disclosed above, paper catalog 124 may reside within DFE 106 of printing device 104. In other embodiments, paper catalog 124 may reside in another component within printing system 100, such as client device 102 or an external server. For brevity, paper catalog 124 is disclosed below as residing within DFE 106.

For each paper type used for a particular model of printing device 104, there are a set of items that work together to achieve optimal reproduction capabilities. These items may be represented in paper catalog 124. An example of a paper catalog entry 302 in paper catalog for a paper type may be shown. Paper catalog 124 may include hundreds or thousands of such entries. Paper catalog entry 302 may be identified within paper catalog 124 by paper type identification 303. In some embodiments, paper type identification 303 may be a unique symbol or code that identifies paper catalog entry 302 within paper groups, disclosed in greater detail below.

Paper catalog entry 302 includes print conditions. Print conditions may be applied to print jobs using paper catalog entry 302. Examples of print conditions may be high quality, default, ink saving, and the like. Each print condition may include its own color printing resources, such as calibration data and ICC profiles. Application of a print condition results in a different result for a print job using paper catalog entry 302 at printing device 104. For example, a high quality print condition will differ in some fashion as a finished, printed document from one printed using the default print condition.

As shown in FIG. 3, paper catalog entry 302 may include print condition 304. It also may include additional print conditions. Print condition 304 may relate to the high quality print condition for printing paper catalog entry 302 at printing device 104. Within print condition, halftones, or halftone designs, may be defined. Printing device 104 may have one or more halftones. Halftones are binary on/off dot patterns of each ink to mimic continuously varying transitions. One halftone could emphasize details in the image, while another could be best for smooth transitions. Thus, print condition 304 includes halftone 306A and halftone 306B. For example, halftone 306A may correspond to the halftone design to emphasize details in the image being printed. Halftone 306B may correspond to the halftone design to provide for smooth transitions.

For each halftone, the print shop should capture the desired per-colorant behavior over all shades of that colorant. By behavior, the disclosed embodiments refer to the color measurement. The record of these colorant behaviors, and the information that allows printing device 104 to be adjusted back to such behaviors, are stored as calibration data. These adjustments may vary linearly or with a curve. The calibration data include characteristics of each ink under the halftone selected. Thus, halftone 306A includes calibration data 308A and halftone 306B includes calibration data 308B.

Further, with a selected halftone, and the calibration data enforced to produce desired behavior of each colorant, the disclosed embodiments then create an ICC profile to fully characterize how ink combinations relate to standardized color measurements, as disclosed above. It is via the ICC profile that, for the specific paper-halftone-calibration-data set up, printing device 104 can reproduce the colors, text, and parameters of the original document. The process for generating an ICC profile is disclosed above. Thus, halftone 306A includes ICC profile 310A and halftone 306B includes ICC profile 310B.

Often printing systems have additional “dials” for more customized controls. For instance, there are settings of total ink amounts allowed in the ICC profile for preserving the glossy finish of a paper. Alternatively, it could be a very conservative expectation of the black ink response set into the calibration data. These more specific customizations may be identified as print conditions. In the scheme of the aforementioned items affecting color management, the disclosed embodiments place print conditions at the highest tier under each paper type, as shown in FIG. 3 by print condition 304.

Paper catalog entry 302 along with print condition 304 and halftones 306A and 306B may refer to the print management resources and items for one paper type. In a print shop, for each model of printing device 104, there may be dozens or more paper types in use. To keep track of the print management items for all these papers, paper catalog 124 may be implemented in system 100. As disclosed above, paper catalog 124 may be a software data storage system that archives all the color management items and resources for each paper type in use. When a print job is specified on a particular paper, identified as paper type identification 303, under a chosen print condition 304 employing halftone 306A, paper catalog 124 will provide the proper corresponding calibration data 308A and ICC profile 310A for printing device 104 to use. If the print job specifies print condition 304 employing halftone 306B, then paper catalog 124 will provide calibration data 308B and ICC profile 310B for printing device 104 to use for the print job.

Paper catalog entry 302 also may include one or more attributes for the paper. For example, first attribute 312 may be the weight of a sheet of paper catalog entry 302. First attribute 312 may be 120 grams per square meter (gsm). Heavier paper is reflected by a higher number for gsm. Generally, heavier paper is associated with a higher quality of stock. It should be noted that dimensions may also be considered an attribute of paper catalog entry 302. Further, first attribute 312 may be considered a dimension of paper catalog entry 302.

Paper catalog entry 302 also may include second attribute 314 and third attribute 316. These attributes may pertain some other feature of the paper of paper catalog entry 302 aside from dimensions and weight. Second attribute 314 may refer to the color of the paper for paper catalog entry 302, such as white, blue, yellow, and the like. Third attribute 316 may refer to a feature of the paper of paper catalog entry 302, such as recycled, new, and the like. Other potential attributes may be glossy or matte paper.

Dimensions and attributes within paper catalog 124 may not necessarily match the attributes for paper trays 108, 110, and 112. Paper trays 108, 110, and 112 also may have attributes that apply to print job 103 as specified by print ticket 126. Dimensions may be included in print ticket 126. Dimensions also may apply to a parameter within paper catalog 124 and paper trays 108, 110, and 112. The other attributes, however, within paper catalog 124 may not apply to any attribute for paper trays 108, 110, and 112.

In some embodiments, calibrations and ICC profiles may be listed in a paper catalog entry 302 but not associated with a print condition. Further, additional print conditions may be listed for each entry. In other words, the print condition may be null within paper catalog entry 302. For example, paper catalog entry 302 may include print condition 304 as disclosed above. It also may include another set of calibration and ICC profile data, such as calibration 308A or 308B and ICC profile 310A or 310B, that is not associated with a print condition.

Paper catalog entry 302 also may include a second print condition that uses a different calibration but perhaps the same ICC profile as the sets not corresponding to a print condition. Further, paper catalog entry 302 may include another group of printing resources for halftone 306B but this is not related to a print condition and includes its own calibration and ICC profile. In other words, printing resources may be listed in a paper catalog entry 302 in a number of ways. Multiple calibrations and ICC profiles may be tied to an entry. The calibration and ICC profiles may still be tied to the integrated resource management operations disclosed herein.

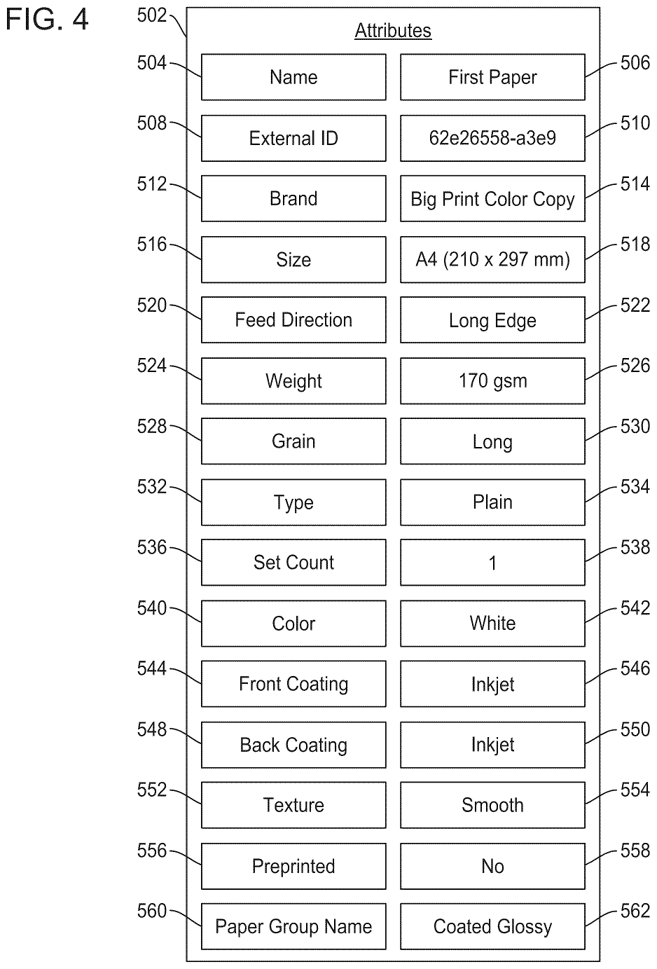

FIG. 4 depicts an example listing of attributes 502 for a specific paper according to the disclosed embodiments. Attributes 502 may be attributes potentially found in a paper catalog entry, such as paper catalog entry 302, disclosed above. The paper may correspond to papers made available to printing device 104 in set of papers 142. First attribute 312, second attribute 314, and third attribute 316 may relate to one of attributes 502. As disclosed below, paper 114 of first paper tray 108 may be used as an example paper for paper catalog entry 302.

Name attribute 504 may refer to the name given for paper 114 in paper catalog 124, at printing device 104, or within printing system 100. Value 506 may be a field with the name, such as First Paper for paper 114. External identification attribute 508 may refer to an external identification number or code for the paper. Value 510 may be a field with the code. Here, the code may be 62e26558-a3e9. Brand attribute 512 may be the brand name for paper 114. Many paper manufacturers have their own names for their papers. For example, Big Print Company may make paper 114 with a brand name of Big Print Color Copy. Thus, value 514 may be a field having Big Print Color Copy.

Size attribute 516 may refer to the size of the paper. Size attribute 516 may correspond to dimensions of the paper. Value 518 may be A4, which is a common reference to a paper size used in printing operations. Other data for value 518 may be letter, legal, A3, or A5. Value 518 also may include the actual dimensions, or 210 mm by 297 mm.

Feed direction attribute 520 may refer to the direction that paper 114 is fed within printing device 104. Value 522 may include long edge as the feed direction. Weight attribute 524 may refer to the weight of paper 114. Value 526 may be the weight in grams per square meter, or gsm. Here, value 526 is 170 gsm. Grain attribute 528 may refer to the grain used by paper 114. Value 530 may be, for example, long for a long grain.

Type attribute 532 may refer to the paper type for paper 114. Value 534, for example, may be plain in that paper 114 is a plain type. Set count attribute 536 may refer to the set count used for paper 114. Value 538, for example, may be 1. Color attribute 540 may refer to the color of paper 114. Value 542, for example, may be white in that paper 114 is white.

Front coating attribute 544 may refer to the coating of the front of paper 114. Value 546, for example, may be inkjet, as opposed to toner or laser, to indicate that paper 114 is to be used in inkjet printing devices. Back coating attribute 548 may refer to the coating of the back of paper 114. Value 550, for example, also may be inkjet. Texture attribute 552 may refer to the texture, or feel, of paper 114. Value 554, for example, may be smooth to indicate that paper 114 has a smooth texture. Preprinted attribute 556 may refer to whether paper 114 is preprinted before being loaded onto printing device 104. Value 558, for example, is no.

Paper group name 560 may refer to a paper group that includes paper 114. The paper group may be generated using one or more attributes 502 in papers within paper catalog 124. Not every paper within the paper group may have all the attributes of paper 114. Here, value 562 for the paper group name may be coated glossy. The coated glossy paper group may be made available to the operator via user interface 120 for selection to export or import. If paper 114 is selected to export, then the disclosed embodiments also provide a first set of papers, or coated glossy, for selection to export. In some embodiments paper group name 560 may be an attribute.

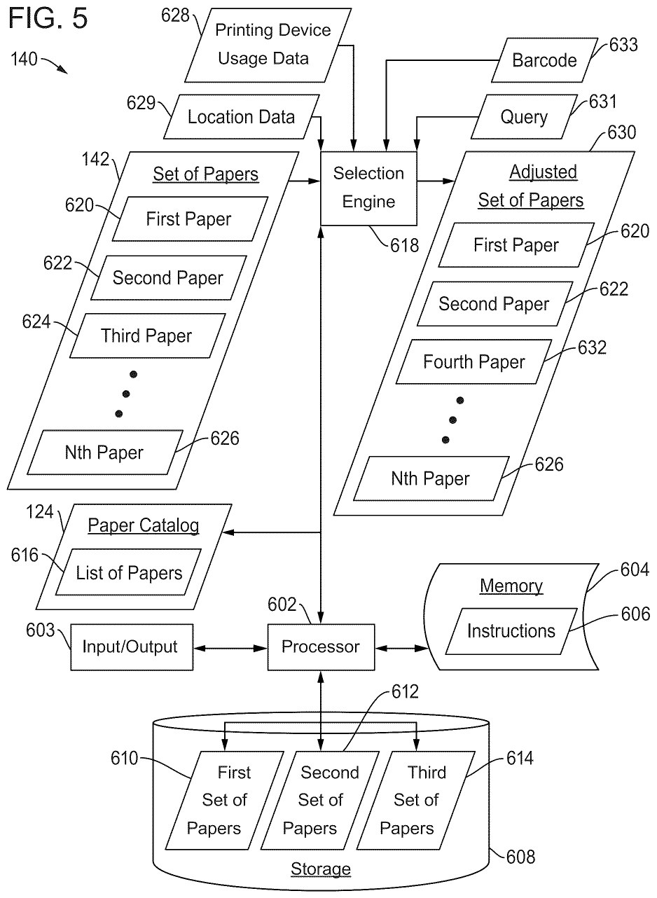

FIG. 5 depicts a block diagram of cloud server system 140 for use within printing system 100 according to the disclosed embodiments. Cloud server system 140 may be a cloud-based server or a plurality of cloud-based servers within system 100. Cloud server system 140 hosts paper catalog 124. Printing devices within system 100 may access cloud server system 140 to download paper catalog 124 to be used in printing operations.

Cloud server system 140 may be connected to multiple printing devices. Cloud server system 140 includes every paper that has been validated for every supported printing device in list of papers 616. Paper catalog 124, therefore, may include paper catalog entries that represent thousands of papers along with their definitions along with weights and sizes as provided in attributes 502.

Cloud server system 140 includes one or more processors 602 that execute instructions 606 stored in memory 604 to configure cloud server system 140 to perform specific functions. Instructions 606 along with processor 602 may configure cloud server system 140 into a special purpose system to manage printing operations within system 100.

Processor 602 is connected to memory 604. Processor 602 also is coupled to input/output module 603. Data and information may be exchanges with the printing devices within system 100 using input/output module 603. In some embodiments, cloud server system 140 may provide paper catalog 124 to a printing device. In other embodiments, cloud server system 140 provides a set of papers 142 to a printing device, which is a set of papers selected from list of papers 616.

Referring back to FIG. 3, paper catalog entry 302 may include a paper definition 330. Paper definition 330 includes metadata 332 to ensure that operators see the relevant paper definition. Metadata 332 may include information about market availability or supported printing devices within system 100 that may use the corresponding paper catalog entry.

When a printing device is installed in system 100, it will query cloud server system 140 to access paper catalog 124 for qualified papers that are available in its region. For example, printing device 104 may be installed in system 100. DFE 106 may query cloud server system 140 to access papers from paper catalog 124. Location data 629 may be provided using devices on printing device 104. Cloud server system 140 may allow the newly installed printing device to download all qualified papers using paper definitions 330 or other criteria from list of papers 616 in paper catalog 124.

Alternatively, the disclosed embodiments may have printing device 104 download a minimal list of papers, or set of papers 142. Set of papers 142 may be generated by selection engine 618 based on a variety of criteria. Set of papers 142 may be a reduced number of papers from list of papers 616 that are selected or tagged as “preferred” papers that are available in the region or location of printing device 104. Printing device 104 may provide location data 629 to cloud server system 140. Selection engine 618 may use location data 629 to pull set of papers 142 from paper catalog entries within paper catalog 124.

For example, cloud server system 140 may include storage 608 that is accessible using one or more processors 602. Cloud server system 140 is connected to multiple printing devices in system 100. Each printing device may have its own set of papers that are used for printing operations. The sets of papers are a reduced number of papers selected from paper catalog 124. Storage 608 may store first set of papers 610, second set of papers 612, and third set of papers 614. First set of papers 610 may apply to a first printing device while second set of papers 612 may apply to a second printing device within system 100. Third set of papers 614 may apply to a third printing device.

Cloud server system 140 may generate a set of papers using location data 629 received from the respective printing device. Sets of papers also may be organized by paper group, or paper definitions. Papers may come in a variety of weights and sizes. Cloud server system 140 may determine which weight or size is preferable for a newly installed printing device. This preference may be client configurable. Using these parameters, selection engine 618 selects a set of papers from paper catalog 124 to be provided to the printing device. It can pull papers of similar weight, size, and the like from paper catalog 124. This set of papers may be stored in storage 608.

In other embodiments, engine settings from print engine 260 or settings from DFE 106 may be used by selection engine 618 to select papers from the set of papers. Further, a type of printing device may have settings stored in cloud server system 140. Yet, the print shop settings may differ from these settings. The disclosed embodiments may modify the settings used by cloud server system 140 to generate the set of papers for the printing device. Thus, the disclosed embodiments allow for local editing to override paper definitions in cloud server system 140.

The use of sets of papers allows for a reduced number of papers to be provided to the DFEs of printing devices. In some embodiments, this feature reduces the need to download an entire paper catalog when installing a printing device. Further, the operator can modify or edit the papers in the set as needed. Paper catalog 124 may be maintained in a central location but made available within system 100. Further, updates may occur.

Printing device 104 may retain a subscription to paper catalog 124. If changes are made to papers in paper catalog 124, then cloud server system 140 may update those sets of papers that include the modified paper catalog entries. The printing devices may automatically download updated paper definitions as they become available. Updated paper catalog entries may be used to update information of corresponding papers in the sets of papers.

Set of papers 142 includes papers from list of papers 616 of paper catalog 124. Printing device 104 may be in a location that uses certain papers in its region so that set of papers 142 includes these papers. Alternatively, papers having a specified weight may be preferred on printing device 104. Set of papers 142 includes first paper 620, second paper 622, third paper 624, up to Nth paper 626. These papers should be available at printing device 104.

During production, printing device 104 using DFE 106 may monitor which papers from set of papers 142 are actually used in printing operations. Printing device 104 may generate printing device usage data 628. Usage data 628 is provided to cloud server system 140. Usage data 628 may be provided to selection engine 618. Selection engine 618 may determine whether to unload unused papers from set of papers 142. For example, a threshold, such as 5%, may be defined. If the amount of usage of a paper is less than 5% of the total amount of paper printed at printing device 104, then selection engine 618 may remove that paper. Alternatively, the threshold may be a number, such as 100. If the total amount of sheets of the paper is less than 100 for a period, such as a week, then that paper should be removed. Unused papers are unloaded or removed from set of papers 142 automatically.

Alternatively, usage data 628 may should usage of a paper not currently in set of papers 142. In those instances, printing device 104 may call cloud server system 100 repeatedly for the paper catalog entry for a paper being used in printing operations. Selection engine 618 may update set of papers 142 with a new paper based on usage data 628. After any adjustments, adjusted set of papers 630 may be provided back to printing device 104. The adjusted set should better reflect the papers actually being used in printing operations. Thus, adjusted set of papers 630 may not include third paper 624. Usage data 628 showed that third paper 624 was not being used at printing device 104. Fourth paper 632 may be added to the selected papers and added to the set of papers provided to printing device 104.

In some embodiments, usage data 628 may show that certain weights or sizes of papers are not used at printing device 104. For example, printing device 104 may rarely use A3 sized paper. These papers may be removed from set of papers 142. Selection engine 618 analyzes usage data 628 to unload papers based on weight or size. Other attributes may be collected in usage data 628 and used to adjust set of papers 142.

In some embodiments, printing device 104 may receive a print job 103 that requests a paper not in set of papers 142. Printing device 104 sends a query 631 to cloud server system 140. Cloud server system 140 may request selection engine 618 to identify the defined paper from query 631. If the paper is found in paper catalog 124, then cloud server system 140 may provide its paper catalog entry or paper definition to printing device 104. Printing device 104 downloads and installs the paper to process print job 103. Clients or operators may define print tickets 126 with minimal information about the paper catalog entry but DFE 106 of printing device 104 would receive complete paper catalog entries that may include not just attributes 502 but print engine attributes needed to ensure optimal production when using the selected paper.

In some embodiments, DFE 106 and printing device 104 may provide the operator the ability to define a set of papers 142 by scanning a barcode 633 for the paper. For example, paper 114 may have an associated barcode 633 that is scanned at printing device 104 or elsewhere in system 100. Barcode 633 is provided to cloud server system 140. Selection engine 618 may find the paper associated with barcode 633 within paper catalog 124. In some embodiments, cloud server system 140 provides the paper catalog entry for the paper to DFE 106. In other embodiments, selection engine 618 may generate a set of papers 142 based on the identified paper. Papers having similar weights or sizes may be included in set of papers 142. Alternatively, paper catalog entries of the paper having different weights and sizes may be included in set of papers 142. All of these actions may be performed on demand.

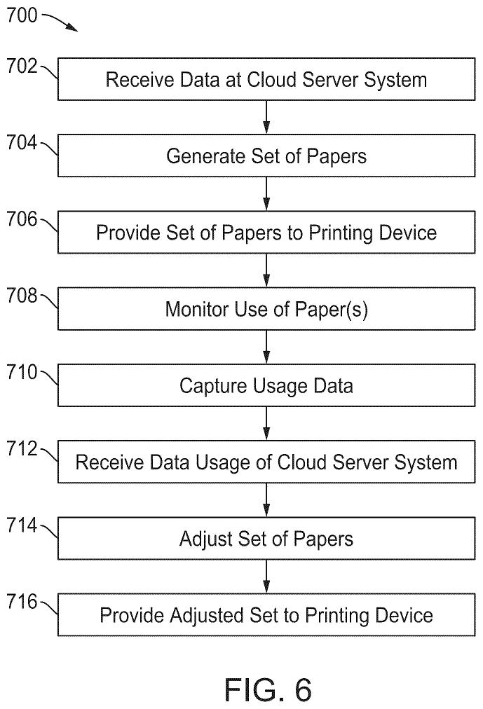

FIG. 6 depicts a flowchart 700 for managing printing operations using a set of papers 142 from a paper catalog 124 of a cloud server system 140 according to the disclosed embodiments. Flowchart 700 may refer to FIGS. 1A-5 for illustrative purposes. Flowchart 700, however, is not limited to the embodiments disclosed by FIGS. 1A-5.

Step 702 executes by receiving data from printing device 104 at cloud server system 140. For example, printing device 104 may be newly installed in system 100 and provides location data 629. Other information may be provided as well. Alternatively, printing device 104 may send a query 631 or a barcode 633 to cloud server system 140.

Step 704 executes by generating a set of papers 142 for printing device 104 based on the received data or information. Selection engine 618 may use criteria based on the received data to select a number of papers from paper catalog 124. For example, there may be papers applicable to the location of printing device 104. The number of papers may be reduced from the list of papers 616 in paper catalog 124 and reflect the papers most likely to be used at printing device 104. For example, the number of papers in set of papers 142 may be 10 to 12. Step 706 executes by providing set of papers 142 to DFE 106 of printing device 104 from cloud server system 140. DFE 106 may treat set of papers 142 as its own paper catalog as it includes the paper catalog entries for the selected papers. DFE 106 will have access to the paper definitions, attributes, print conditions, and the like from the paper catalog entries from paper catalog 124 in set of papers 142.

Step 708 executes by monitoring use of one or more papers at printing device 104. Step 710 executes by capturing printing device usage data 628 by DFE 106. For example, for a period of time, such as a month, DFE 106 may capture the number of sheets of each paper of set of papers 142 printed using printing device 104. DFE 106 may generate printing device usage data 628. Step 712 executes by receiving usage data 628 at cloud server system 140.

Step 714 executes by adjusting set of papers 142 based on usage data 628. As disclosed above, selection engine 618 may identify one or more papers that are not being used at printing device 104. Alternatively, selection device 618 may identify one or more papers in paper catalog 124 that are being used but are not listed within set of papers 142. Selection engine 618 may remove a paper from set of papers 142 or add a paper from paper catalog 124 based on the analysis of usage data 628. Cloud server system 140 may generated an adjusted set of papers 630.

Step 716 executes by providing adjusted set of papers 630 to DFE 106 of printing device 104. Thus, DFE 106 may dynamically and automatically update its own paper catalog using the data collected during printing operations at printing device 104. The operator does not need to manually check or change the papers provided in set of papers 142. This feature also keeps the amount of data storage for its paper catalog small for DFE 106.

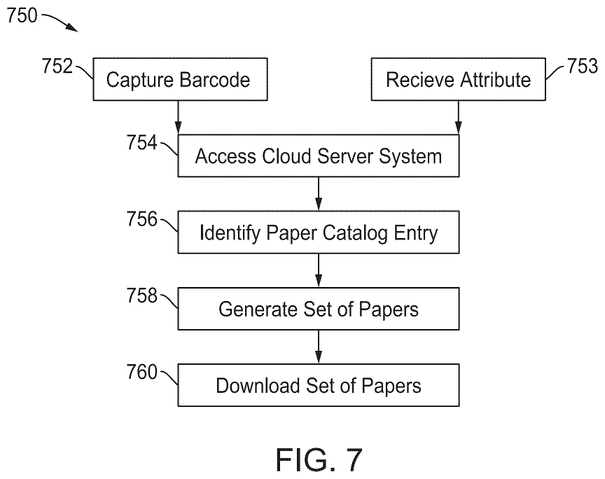

FIG. 7 depicts a flowchart 750 for generating a set of papers 142 based on a barcode 633 or an attribute in a print ticket 126 according to the disclosed embodiments. Flowchart 750 may refer to FIGS. 1A-6 for illustrative purposes. Flowchart 750, however, is not limited to the embodiments disclosed by FIGS. 1A-6.

Step 752 executes by capturing barcode 633 of a paper, such as paper 114, at printing device 104. Printing device 104 may use scanner components 224 to capture barcode 633. DFE 106 may associate barcode 633 with paper 114 and forward to cloud server system 140. Step 754 executes by accessing cloud server system 140 by DFE 106. DFE 106 may open a connection within system 100 to cloud server system 140. DFE 106 provides barcode 633 to cloud server system 140.

Step 756 executes by identifying a paper catalog entry, such as entry 302, for paper 114 represented by barcode 633. Selection engine 618 may determine which paper is being referenced by barcode 633 and identifies the respective paper catalog entry for paper 114. Step 758 executes by generating set of papers 142 for printing device 104 based on the selected paper. The processes of generating set of papers 142 are disclosed above. For example, set of papers 142 may be papers from paper catalog 124 having similar sizes and weights as paper 114.

Step 760 executes by downloading set of papers 142 from cloud server system 140 to DFE 106 of printing device 104. Thus, a set of papers 142 may be generated automatically from paper catalog 124 based on barcode 633 of a paper. DFE 106 may receive its own paper catalog list of papers using set of papers 142.

In some embodiments, instead of a barcode, an attribute defined in a print ticket of a print job may be used to generate set of papers 142. Print ticket 126 of print job 103 may include parameters 128 that include attributes, such as attributes 502, that may be used to select papers from paper catalog 124. Query 631 from DFE 106 may include one or more attributes specified in the print ticket settings. Step 753 executes by receiving the attribute related to print ticket 126 at cloud server system 140. Steps 754-760 may be executed as disclosed above, but with the attribute being used by selection engine 618 to generate set of papers 142. Selection engine 618 would return a set of papers that match the attribute for print job 103.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” or “comprising,” when used in this specification, specify the presence of stated features, integers, steps, operations, elements, or components, but do not preclude the presence or addition of one or more other features, integers, steps, operations, elements, components, and/or groups thereof.

Embodiments may be implemented as a computer process, a computing system or as an article of manufacture such as a computer program product of computer readable media. The computer program product may be a computer storage medium readable by a computer system and encoding computer program instructions for executing a computer process.

When accessed, the instructions cause a processor to enable other components to perform the functions disclosed above.

The corresponding structures, material, acts, and equivalents of all means or steps plus function elements in the claims below are intended to include any structure, material or act for performing the function in combination with other claimed elements are specifically claimed. The description of the present invention has been presented for purposes of illustration and description, but is not intended to be exhaustive or limited to the invention in the form disclosed. Many modifications and variations will be apparent to those of ordinary skill without departing from the scope and spirit of the invention. The embodiment was chosen and described in order to best explain the principles of the invention and the practical application, and to enable others of ordinary skill in the art to understand the invention for embodiments with various modifications as are suited to the particular use contemplated.

One or more portions of the disclosed networks or systems may be distributed across one or more printing systems coupled to a network capable of exchanging information and data. Various functions and components of the printing system may be distributed across multiple client computer platforms, or configured to perform tasks as part of a distributed system. These components may be executable, intermediate or interpreted code that communicates over the network using a protocol. The components may have specified addresses or other designators to identify the components within the network.

It will be apparent to those skilled in the art that various modifications to the disclosed may be made without departing from the spirit or scope of the invention. Thus, it is intended that the present invention covers the modifications and variations disclosed above provided that these changes come within the scope of the claims and their equivalents.

1. A method for managing printing operations in a printing system, the method comprising:
enabling a set of papers from a paper catalog stored in a cloud server system at a printing device;
monitoring a use of at least one paper of the set of papers during production at the printing device;
adjusting the set of papers based on the use of the at least one paper by a digital front end (DFE) of the printing device; and
providing the adjusted set of papers for a print job at the printing device.

2. The method of claim 1, wherein the adjusting the set of papers includes removing the at least one paper from the set of papers.

3. The method of claim 1, further comprising receiving a request for a paper not within the set of papers for printing at the printing device.

4. The method of claim 3, further comprising adding the requested paper to the set of papers.

5. The method of claim 4, further comprising downloading at least one attribute for the requested paper from the paper catalog in the cloud server system.

6. The method of claim 1, further comprising defining a subset of papers from the set of papers based on a parameter of at least one subset paper of the subset of papers.

7. The method of claim 6, wherein adjusting the set of papers includes adjusting the set of papers based on the use of the parameter of the subset of papers.

8. The method of claim 6, wherein the parameter includes at least one of a size of the at least one subset paper of the subset of papers and a weight of the at least one subset paper of the subset of papers.

9. The method of claim 1, further comprising updating paper definitions for each paper of the set of papers from the paper catalog from the cloud server system at the printing device.

10. The method of claim 1, further comprising adding the printing device to the printing system.

11. The method of claim 10, further comprising connecting the printing device to the cloud server system.

12. The method of claim 11, further comprising downloading the set of papers to the printing device based on a location of the printing device.

13. A method for managing printing operations for a printing system, the method comprising:
capturing a barcode associated with a paper specified by a print job at a printing device within the printing system;
accessing a cloud server system of the printing system by a digital front end (DFE) of the printing device;
identifying a paper catalog entry for the paper in a paper catalog at the cloud server system;
generating a set of papers from the paper catalog based on the paper catalog entry; and
downloading the set of papers from the cloud server system to the DFE of the printing device.

14. The method of claim 13, further comprising receiving a print job within the printing system for the printing device, wherein the print job includes a setting related to the paper.

15. The method of claim 13, further comprising scanning the barcode for the paper at the printing device.

16. The method of claim 13, wherein the set of papers includes additional versions of the paper that vary in weight or size.

17. A method for managing printing operations, the method comprising:
receiving an attribute defined in a print ticket setting for a print job received for a printing device in a printing system;
accessing a cloud server system of the printing system by a digital front end (DFE) of the printing device;
identifying at least one paper catalog entry from a paper catalog having the attribute, wherein the paper catalog is hosted by the cloud server system;
generating a set of papers from the paper catalog based on the at least one paper catalog entry; and
downloading the set of papers from the cloud server system to the DFE of the printing device.

18. The method of claim 17, wherein the set of papers includes additional versions of the at least one paper that vary in weight or size.

19. The method of claim 17, wherein generating the set of papers includes generating the set of papers also based on a print engine setting of the printing device.

20. The method of claim 19, wherein the print engine setting is a print engine speed.
